(19) United States
(12) Patent Application Publication
(10) Pub. No.: US 2006/0053436 A1
(43) Pub. Date: Mar. 9, 2006

(54) Wireless back channel for satellite television system

(75) Inventors: Edward Allwein, Castle Rock, CO (US); Michael Dugan, Parker, CO (US); Mark H. Gomez, Parker, CO (US)

Correspondence Address: MERCHANT & GOULD PC, P.O. BOX 2903, MINNEAPOLIS, MN, 55402-0903, US

(73) Assignee: EchoStar Technologies Corporation

(21) Appl. No.: 10/936,191

(22) Filed: Sep. 7, 2004

(51) Int. Cl. H04N 7/16; H04N 7/173

(52) U.S. Cl. 725/1; 725/2; 725/62; 725/105

(57) ABSTRACT

The present invention solves the above problems by attaching a cellular phone receiver to the set-top-box. This cellular phone receiver has a modem to transmit data between the subscriber's box and a cellular network. The cellular network may relay the data to the pay-television distributor. Other features and advantages of the present invention will become apparent from the following detailed description of the invention and the accompanying drawings.

### FIELD OF THE INVENTION

The present invention relates to television converter devices. More specifically, the invention provides a method and apparatus for wirelessly communicating to a television converter device.

### BACKGROUND OF THE INVENTION

The prior art includes various devices which can be used to receive pay-television signals. Pay television service involves a pay television distributor sending television signals to subscribers. These subscribers are given or pay for a television converter. Television converters are commonly known as cable boxes or satellite television set-top-boxes. These boxes receive and decode the pay-television signal for authorized display on a television set or monitor.

Many of the pay-television distributors need to receive communications from set-top-boxes. Communications may include pay-per-view purchase records or other types of information. These communications may be shown on the television or may affect the operation of the set-top-box.

Many current pay-television systems utilize a phone line connected to the set-top-box. The phone line acts as a communications pathway between the pay-television distributor and the subscriber. It is desirable to provide an alternative communications pathway where a phone line is not available or not connected. Sometimes the subscriber installs the television system or set-top-box where a phone line is not available. In recent years, many people have switched exclusively to wireless or cellular phones and may not have a residential telephone line to communicate to the pay-television distributor. In other installations, the subscriber fails to or forgets to connect the phone line. In some situations, the subscriber may simply refuse to install the phone line. Thus, there exists a need to provide a communications pathway between the subscriber and the pay-television distributor that does not rely on a landline phone. There also exists a need for a communications pathway between the set-top-box to the pay-television distributor that cannot be inadvertently or intentionally disconnected by a subscriber.

Some subscribers who do not have access to a landline phone line may nevertheless also wish to connect a landline telephone unit for use with this alternative communications pathway. A need therefore exists to permit the use of a subscriber's conventional landline telephone unit via the alternative communications pathway.

### BRIEF SUMMARY OF THE INVENTION

The present invention solves the above problems by attaching a wireless phone device and antenna to the set-top-box. This wireless phone system transmits data between the subscriber's box and a wireless network. The cellular network may relay the data to the pay-television distributor. Other features and advantages of the present invention will become apparent from the following detailed description of the invention and the accompanying drawings.

### BRIEF DESCRIPTION OF THE SEVERAL VIEWS OF THE DRAWINGS

FIG. 1 is a high level block diagram of a system using a television converter and a wireless device of an embodiment of the present invention.

FIG. 2 is a high level block diagram of a television converter of an embodiment of the present invention.

FIG. 3 illustrates one embodiment of a wireless back channel.

FIG. 4 illustrates another embodiment of a wireless back channel.

FIG. 5 illustrates yet another embodiment of a wireless back channel.

FIG. 6 illustrates the logical steps of one embodiment of a method for utilizing a wireless back channel.

FIG. 7 illustrates the logical steps of a second embodiment of a method for utilizing a wireless back channel.

FIG. 8 is a high level block diagram of a system using a television converter, wireless device and an attached telephone base station of an embodiment of the present invention.

For clarification, the drawings use a nomenclature for reference numerals that has two parts. The first part of the reference numeral is the drawing number, and it is followed by the second part, a two digit identifier (drawing 1 uses 1xx; drawing 3 uses 3xx). For example, two reference numerals in drawing 1 may be “102” and “104.” A reference numeral in one drawing may be referred to in subsequent drawings; the same reference numeral in later drawings refers to the same item.

### DETAILED DESCRIPTION OF THE INVENTION

In this specification, the present invention will be described using methods and systems related to subscriber satellite television service. This specific description is not meant to limit the invention to that one embodiment. The present invention may also be applicable to cable television systems, broadcast television systems or other television systems. The present invention is also described in terms of digital video recording (DVR) devices. The present invention may also be applicable to digital-versatile-disc (DVD) recording devices or other television recording devices. One skilled in the art will recognize that the present invention can apply elsewhere.

As a general matter, the disclosure uses the term “signal.” One skilled in the art will recognize that the signal may be any digital or analog signal. Those signals may include, but are not limited to, a bit, a specified set of bits, an A/C signal, or a D/C signal. Uses of the term “signal” in the description may include any of these different interpretations. It will also be understood to one skilled in the art that the term “connected” is not limited to a physical connection but can refer to any means of communicatively or operatively coupling two devices.

As another general matter, the disclosure uses the terms “television converter,” “receiver,” “set-top-box,” “television receiving device,” “television receiver,” “television recording device,” “satellite set-top-box,” “satellite receiver,” “cable set-top-box,” “cable receiver,” and “television tuner” to refer interchangeably to a converter device or electronic equipment that has the capacity to acquire, process and distribute one or more television signals transmitted by broadcast, cable, telephone or satellite distributors. “Digital video recorder (DVR)” and “personal video recorder (PVR)” refer interchangeably to devices that can digitally record and play back television signals and that may implement trick functions including, but not limited to, fast-forward, rewind and pause. As set forth in this specification and the figures pertaining thereto, DVR and PVR functionality or devices may be combined with a television converter. The signals transmitted by these broadcast, cable, telephone or satellite distributors may include, individually or in any combination, internet, radio, television or telephonic data or information. One skilled in the art will recognize that a television converter device may be implemented as an external self-enclosed unit, a plurality of external self-enclosed units or as an internal unit housed within a television. One skilled in the art will recognize that the present invention can apply to analog and digital satellite set-top-boxes.

As yet another general matter, it will be understood by one skilled in the art that the term “television” refers to a television set or video display that may contain an integrated television converter device (e.g., an internal cable-ready television tuner housed inside a television) or, alternatively, that is connected to an external television converter device (e.g., an external set-top-box connected via cabling to a television). A further example of an external television converter device is the EchoStar Dish PVR 721, Part Number 106525, combination satellite set-top-box and PVR. For the remainder of this disclosure, specific embodiments will be described using a television converter device that implements satellite technology.

Finally, as a general matter, it should be understood that satellite television signals may be very different from broadcast television or other types of signals. Satellite signals may include multiplexed, packetized, and modulated digital signals. Once multiplexed, packetized and modulated, one analog satellite transmission may carry digital data representing several television stations or service providers. Some examples of service providers include HBO™, CSPAN™, ABC™, CBS™, or ESPN™. In satellite television, a service provider can also be compared to a “channel.”

The term “channel,” as used in this description, carries a different meaning from its normal connotation. In broadcast television, different analog signals of a television station may be carried on a carrier frequency and its sub-channels. A tuner in a television may then acquire and process these signals. In broadcast television, the term channel has thus become synonymous with the sub-channel or the station on that sub-channel. The normal connotation of the term “channel” is therefore not always appropriate to describe satellite television transmissions where multiple stations may be multiplexed onto a single carrier frequency. Satellite television distributors, however, may organize the satellite data into a group of different “virtual channels.” These virtual channels give the impression that the satellite television programs are placed in normal channels that are organized by service provider. This impression may assist user operation of the satellite set-top-box since it models an analog television or analog receiving device. The virtual channels may appear in the electronic program guide (EPG) data and the user may choose programming by selecting a virtual channel. For instance, the user can select HBO, which may be on virtual channel 300, or CSPAN, which may be on virtual channel 210. These service providers or virtual channels are not necessarily carried in the same signal being sent from the same satellite. EPG data may come from a service provider (e.g., HBO), content provider (e.g., Disney), a third party (e.g., TV Guide) or from another outside entity.

Thus, in satellite television service a channel may not be the same as in broadcast television service. Rather, channels may be more properly termed service providers in satellite television service. The term “channel” will be used in this description to describe the service providers and the virtual channels they may occupy.

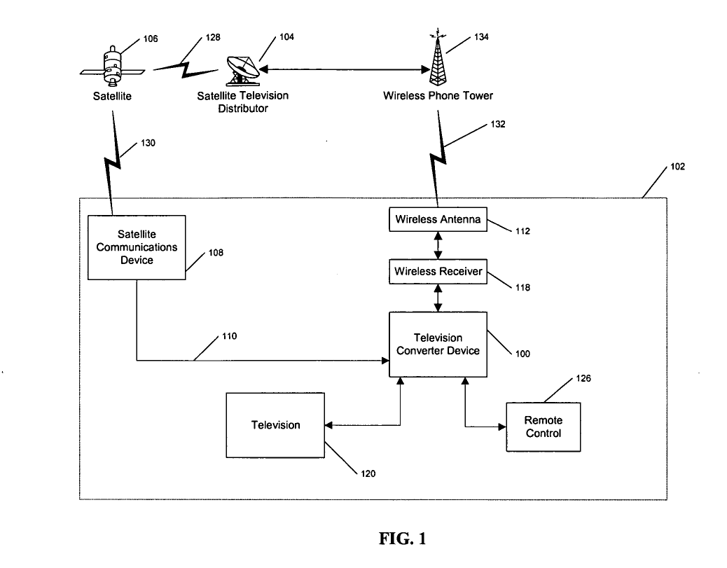

FIG. 1 presents an embodiment of a home entertainment system 102 that includes a television converter device 100 in the form of a satellite set-top-box. Generally, the satellite set-top-box 100 may receive one or more television signals from a cable television distributor (not shown), from a broadcast television distributor (not shown) or from a satellite television distributor 104. As a preferred embodiment, home entertainment system 102 receives signals from satellite television distributor 104. One skilled in the art will recognize that set-top-box 100 may also receive video-digital subscriber line (DSL), DSL, Internet, wireless and other signals from content or video distributors. The satellite set-top-box 100 may process television signals and may send the processed signals to peripheral electronic devices, such as a monitor or television 120. The satellite set-top-box 100 also may accept commands from a remote control 126 or other peripheral electronic devices. More detail about the functionality of the satellite set-top-box 100 is provided below.

To further describe the home entertainment system, embodiments relating to receiving satellite television signals will be explained in more detail. A satellite television distributor 104 may transmit one or more satellite television signals 128 to one or more satellites 106. Satellite television distributors may utilize several satellites 106 to relay the satellite television signals to a subscriber. Each satellite 106 may have several transponders. Transponders transmit the signal 130 from the satellite to the subscriber. For example, these signals 130 may be transmitted at a frequency of 2150 Mhz.

A transponder may also polarize the transmitted signal 130 in several ways. One form of polarization in satellite transmissions is circular polarization. For example, transponders of satellite 106 may transmit two signals (together as signal 130) on the same transponder, one signal that is right-hand polarized and another signal that is left-hand polarized. In other words, two signals may be simultaneously transmitted with opposite polarizations. The opposite polarizations may prevent interference. One skilled in the art will recognize that other ways of polarizing signals are possible.

The polarized signals can be received at satellite communication device 108. The satellite communication device 108 may include one or more of the components that follow. One component of satellite communication device 108 may be a satellite dish. A satellite dish can focus the signal on one or more low-noise block filters (LNBF), also referred to as low-noise block down converters (LNBDC). The LNBFs may de-polarize and initially process the signal. This initial processing may include filtering noise from the signal and down-converting the signal. Down-conversion is sometimes required to transmit the signal 110 through certain cables, such as coaxial cables. The signal 110 arrives at the television converter device 100 via cabling. One skilled in the art will recognize that other methods and other systems of delivering the satellite signal 110 to the satellite set-top-box 100 may be possible.

A common connection to television converter device 100 and home entertainment system 102 is a phone line (explained below). However, embodiments of television converter device 100, in accordance with the present invention, may not include or use a landline phone connection. In a preferred embodiment, the television converter device 100 may instead use a wireless antenna 112 and a wireless device 118 that can receive or send signals 132 to a wireless phone tower 134. The wireless phone tower 134 may relay the signals 132 to a wireless telecommunications network (not shown) that may then send the signals 132 to satellite television distributor 104. In a preferred embodiment, a two-way data-capable wireless communication device such as a cellular phone or similar electronics may be used for the wireless device 118. The wireless device 118 may include a data capable cellular modem or other data capable device. Two examples of wireless devices 118 are the Motorola StarTac 8600 or the Nokia 7160 cellular telephones. The wireless device 118 can be used by the television converter 100 to communicate with one or more of the pay-television distributors. These communications may include requesting pay-per-view programming, reporting of purchases (for example, pay-per-view purchases), obtaining updates to subscriber programming, receiving updates to software on the satellite set-top-box 100. One skilled in the art will recognize that there may be other uses for this wireless connection. One skilled in the art will also recognize that the phone line (not shown) and the combination of the wireless device 118 and antenna 112 are not mutually exclusive connections to the set-top-box 100. In other embodiments, the set-top-box 100 may include both a phone line and the combination of a wireless device 118 and wireless antenna 112.

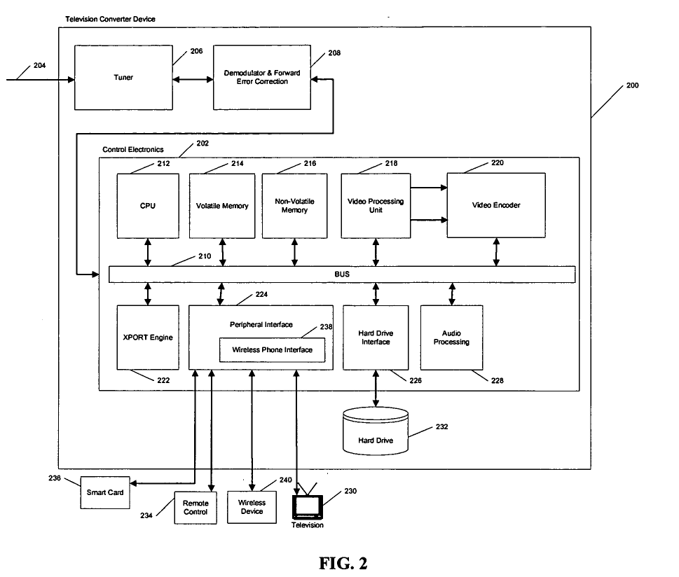

FIG. 2 provides a high level block diagram for the satellite television converter device 100, 200 with DVR functionality in accordance with the present invention.

The signal 110, 204 that arrives at the satellite set top box 200 may undergo extensive processing. The television converter 200 may include one or more tuner devices 206 that may receive a satellite signal 204. In this embodiment, tuner device 206 acquires a satellite signal 204 from satellite television distributor 104. Tuner device 206 may initially process the satellite signal 204. Tuner device 206 may also receive subscriber commands in the form of signals from control electronics unit 202. Signals from control electronics unit 202 may include, but is not limited to, a signal to tune to a transponder as part of the process of selecting a certain channel for viewing on a peripheral device. One skilled in the art would recognize that the tuner device 206 may include fewer, more, or different components.

After receiving the signal 204, one of the first steps may be to demodulate 208 the signal 204. The signal 204 may arrive as an analog signal that “carries” data (e.g., data is modulated onto the analog signal). Demodulation 208 may be accomplished by reversing the modulation process. Modulation can be done in several ways. Modulation may include amplitude modulation (AM) or frequency modulation (FM). If the carried data is digital, modulation methods include, but are not limited to, biphase-shift keying (BPSK), quadraphase-shift keying (QPSK), or eight-phase shift keying (8PSK). One skilled in the art will recognize that other methods of modulating and demodulating the signal 204 may be possible. Another one of the first steps may also be to error check 208 signal 204. One example of error checking 208 is forward error-checking. Forward error-checking (FEC) 208 may include, but is not limited to, inspecting parity bit or bits that may accompany signal 204. One skilled in the art will recognize that many methods for error checking are possible. For the purposes of discussion, an embodiment using digital data will be discussed below. However, one skilled in the art will recognize that systems with analog data or combined analog and digital data are also possible and contemplated herein.

In this embodiment, satellite set-top-box 200 contains control electronics unit 202 that receives satellite signal 204. One skilled in the art will recognize that control electronics 202 may receive other signals, including, but not limited to, signals from a cable or broadcast television distributor. One example of a control electronics unit 202 is the STMicroelectronics STi5517 Low-Cost Interactive Set-top Box Decoder, Part No. 7424736A. In a preferred embodiment, control electronics unit 202 includes discrete electronic components combined into a single circuit with a shared bus 210. In other embodiments, control electronics unit 202 may be configured differently. For example, one or more of the control electronics unit 202 components in set-top-box 200 may be combined or omitted. The control electronics unit 202 may use a custom ASIC, such as from the LSILogic G11 family, or FPGA, such as from the Altera Stratix™ family. As a further example, one or more of the control electronics unit 202 components in set-top-box 200 may not share a bus 210, but may nonetheless be operatively connected by some other means. One skilled in the art will recognize that other configurations of set-top-box 200 and control electronics unit 202 are possible and within the scope of this invention. One skilled in the art will further recognize that some components of set-top-box 200 and control electronics unit 202 may be implemented in hardware or software. The control electronics unit 202 may operate under the control of a software program, firmware program, or some other program stored in memory or control logic. One skilled in the art will also recognize that the control electronics unit 202 may include other electronic components or structures to mediate or process signals.

Control electronics unit 202 may contain one or more central-processing-units (CPUS) 212 or processors. A preferred embodiment of control electronics unit 202 contains a single CPU 212 that is operatively connected to the shared bus. In one embodiment, CPU 212 may be used, among other things, for logical operations for set-top-box 200 functions including, but not limited to, channel selection, recording control, EPG display and control and system maintenance. Examples of commercially available CPUs 212 include the STMicroelectronics Enhanced ST20 32-bit VL-RISC, Motorola 68000 or Intel Pentium processors. One skilled in the art will recognize that the CPU 212 may be integrated with memory or other discrete electronics components.

Control electronics unit 202 may also contain one or more volatile memory components 214. Volatile memory components 214 may include, but are not limited to, one or more SDRAM memory chips. Similarly, control electronics unit 202 may contain non-volatile memory components 216. Non-volatile memory 216 may include one or more memory chips, including, but not limited to, ROM, SRAM, SDRAM and Flash ROM. One skilled in the art will recognize that volatile memory 214 and non-volatile memory 216 may be integrated within other electronics components. One skilled in the art will also recognize that other memory components may be included within set-top-box 200 and control electronics unit 202. One skilled in the art will recognize that memory 214, 216 may be used for many purposes, including, but not limited to, storing EPG data and storing data for use by CPU 212.

In a preferred embodiment, signal 204 is in digital form (e.g., a digital stream) after demodulation and error correction. For example, digital stream 204 may use, but is not limited to using, the digital video broadcasting (DVB) transport standard. The digital stream 204 may be multiplexed and therefore require demultiplexing by XPORT Engine 222. Demultiplexing, or demuxing, may include separating the bits of data into separate digital data streams. The digital streams may be packetized. Thus, the multiplexing of the separate digital data streams may not be bit-by-bit but packet-by-packet. The packet size may vary or may be constant. After demuxing 222 the packets, the separate digital data streams may be reassembled by placing related packets together in a continuous data stream 204.

Each of the separate digital data streams may also be encoded. Encoding is a method for representing data. Encoding may allow the data to be compressed. Compression can provide the system with increased bandwidth. One skilled in the art will recognize that several different encoding formats are possible. In satellite television, encoding formats may include the MPEG or MPEG2 standards. Beyond the raw data, the separate digital data streams may include forward error correction, headers, checksums, or other information. All of this different information may be included in the digital television signal 204 processed by the satellite set-top-box 100. Control electronics unit 202 may therefore include one or more video processing units 218 that, among other video processing operations, may decode encoded signal 204. In a preferred embodiment, video processing unit 218 may include, but is not limited to, a graphics processor, MPEG-2 decoder and a display compositor with separate on-screen display (OSD) control for peripheral devices. One skilled in the art will recognize that video processing unit 218 may also include other electronics, including, but not limited to, alpha blending, antialiasing, antiflutter and antiflicker filters, memory and video-rendering components.

Another discrete electronic component of control electronics unit 202 may be a video encoder unit 220. Video encoder unit 220 may work in combination with or independently from video processing unit 218. Video encoding unit 220 may encode digital stream 204 for output to one or more peripheral devices, including, but not limited to, a television. For example, video encoding unit 220 may encode digital stream 204 for RGB, CVBS, Y/C and YUV outputs. Encoding may allow program data to be compressed. As a preferred embodiment, video encoder 220 may translate digital stream into a signal using the NTSC, PAL or SECAM standards. One skilled in the art will recognize that video encoder unit 220 may include other functionality, may be integrated into other electronic components of satellite set-top-box 200, and may encode digital stream 204 using other standards, including, but not limited to, MPEG and MPEG2.

Control electronics unit 202 may also include one or more hard drive interfaces 226 and hard drives 232. In a preferred embodiment, television converter device 200 contains one hard drive interface 226 and hard drive 232. Hard drive 232 may be used for many purposes, including, but not limited to, storing recorded programs, buffering currently-playing programs (e.g., buffering a program may allow a user to pause or rewind a program), storing EPG data, storing commands or functions for the control electronics unit 202, storing timers or record events, and storing data for other devices within or connected to the satellite set-top-box 200. As another example, hard drive 232 may be used to temporarily store data for processing by CPU 212. In this example, the hard drive 232 may allow the processor 212 to separate EPG data arriving as part of digital stream 208. One skilled in the art will recognize that other storage devices and interfaces may be substituted for hard drive interface 226 and hard drive 232 and are within the scope of this invention. One skilled in the art will also recognize that hard drive interface 226 and hard drive 232 may separately or together include an integrated memory (e.g., a memory buffer, commonly known referred to as cache) and additional processing components or logic. One skilled in the art will also recognize that hard drive interface 226 may be integrated into peripheral interface 224 (described below). Finally, one skilled in the art will recognize that hard drive 232 may be external and connected to satellite set-top-box 200. For example, an external hard drive 232 may be connected to satellite set-top-box 200 using USB 2.0 or IEEE 1394 (FireWire) connections. Such an external hard drive may include a screen for portable viewing of programming stored on it.

An audio processing unit 228 may also be part of the control electronics unit 202. Audio processing unit 228 may decode the digital stream 204 for output to peripheral devices, including, but not limited to, a stereo, television speakers or portable audio or video players. For example, audio processing unit 228 may decode MPEG-1 layers I/II and layer III, Dolby Digital, Dolby ProLogic, SRS/TruSurround encoded audio in digital stream 204. Audio processing unit 228 may include one or more processors, memory components or digital to audio converter (DAC) systems. One skilled in the art will recognize that other audio processing components and functionality may be accomplished using audio processing unit 228.

A satellite set-top-box 200 may be connected to one or more peripheral electronic devices through peripheral interface 224. These peripheral devices may include a stereo (not shown), television 230, smart card 236, VCR (not shown), or other devices. In a preferred embodiment, home entertainment system 102 minimally contains, but is not limited to, a television 230 and smart card 236. Television 230 may serve many purposes, including, but not limited to, displaying television programming, displaying the EPG, displaying timer conflicts, and displaying other types of data, graphics and programming. Peripheral devices may receive and/or send signals from the satellite set-top-box 200. For instance, the television 230 may receive video and audio signals and a stereo may receive only audio signals. A camcorder (not shown), on the other hand, may send video or audio signals to the satellite set-top-box 100 or receive audio and video signals from the set-top-box to record. As another example, peripheral interface 224 may include a processor or other electronic components to permit an interface to content security devices such as an external “smart card.” In this example, peripheral interface 224 may then encrypt or decrypt content for output to other peripheral devices. Thus, peripheral interface 224 may perform one or more functions for multiple peripheral devices, including, but not limited to, the synchronous or asynchronous transfer of data between different peripheral devices (e.g., decrypting content using a smart card peripheral device and outputting decrypted content to a television at the same time). One skilled in the art will recognize that the peripheral devices may include many types of commercially available electronic devices.

The home entertainment system 102 may also include a remote control 126, 234 peripheral device, also sometimes referred to as a remote. The remote control 234 may be used to send commands to the satellite set-top-box 200. The remote control 234 may send commands via a wireless connection using, for example, infrared or UHF transmitters within the remote control 234. One example of an embodiment of a remote controller 234 is the EchoStar Technologies Corporation 721 Platinum Plus Remote, Part Number 121150, that includes an IR transmitter and an ultra high frequency (UHF) transmitter. The remote control 234 may be able to send signals to other peripheral electronic devices that form part of the home entertainment system 102, including, but not limited to, a television, stereo, VCR, or DVD player. The set-top-box 200 may also be able to send signals to the remote control 234, including, but not limited to, signals to configure the remote control 234 to operate other peripheral devices in home entertainment system 102. In some embodiments, the remote control 234 has a set of Light Emitting Diodes (LEDs). Some remote controls may include Liquid Crystal Displays (LCDs) or other screens. The remote control may include buttons, dials, or other man-machine interfaces. While the remote control 234 may often be the common means for a subscriber to communicate with the satellite set-top-box 200, one skilled in the art will recognize that other means of communicating with the set-top-box 200 are available, including, but not limited to attached keyboards, front panel buttons or touch screens.

The satellite set-top-box 200 may also include a remote control interface (not shown). A remote control interface may include any means for the user to communicate to the satellite set-top-box 200, and may be implemented using the peripheral interface 224 of control electronics unit 202 or by connecting a peripheral remote control interface device. In a preferred embodiment, a remote control interface may receive commands from one or more different remote controls 234. Remote control 234 may use infrared, UHF, or other communications technology. The remote control interface may therefore translate an input from the user into a format understandable by the control electronics unit 202. The translation systems may include, but are not limited to, electronic receivers and electronic relays. One skilled in the art will recognize that other means to receive and translate user inputs are possible.

Another peripheral device and connection to the satellite set-top-box 200 may include a phone line (not shown) and modem (not shown). Set-top-box 200 may use a modem and phone line to communicate with one or more outside entities or systems (e.g., satellite television distributor 104). The phone line may carry local or long-distance telephone service. One skilled in the art will recognize that the phone line may also carry other services, including, but not limited to, DSL service. These communications may include requesting pay-per-view programming, obtaining updates to subscriber programming (e.g., updating EPG data), or receiving updates to software on the satellite set-top-box 200. For example, the phone line may communicate with the satellite set-top-box 200 using an RJ-11 style telephone connection. One skilled in the art will recognize that there are many other uses for this phone line connection. For example, EPG data may be transmitted to set-top-box 200 via phone line or in the satellite signal 204. One skilled in the art will recognize that the EPG data may be transmitted to set-top-box 200 by various other methods, systems and outside entities. Also, one skilled in the art will recognize that a phone line connection to satellite distributor 104 may represent other communication connections, including, but not limited to, wireless, Internet, or microwave communications connections. Another function of the phone line may be to periodically receive the EPG data.

The peripheral interface 224 of satellite set-top-box 200, in accordance with the present invention, includes a wireless phone interface 238. One skilled in the art will recognize that the wireless phone interface 238 may be embodied in hardware or software. One skilled in the art will also recognize that the wireless phone interface 238 may be integrated with another component or components of the satellite set-top-box 200. In this embodiment, the satellite set-top-box 200 includes a wireless phone interface 238 to communicate with a wireless phone device 240 that is externally connected to satellite set-top-box 200. In other embodiments, the wireless phone interface 238 may include connections to one or more wireless phone devices 240 that are integrated within television converter device 200. The wireless phone interface 238 may transmit signals in DiSeqC protocol to the wireless phone device 240. One skilled in the art will recognize that other protocols are possible for device communication with a wireless phone device 240. The wireless phone device 240 may need to translate the DiSeqC protocol messages into a wireless transmission protocol. Wireless transmission protocols may include, but are not limited to, Advanced Mobile Phone System (AMPS), Advanced Radio Data Information Service (ARDIS), Code Division Multiple Access (CDMA), Cellular Digital Packet Data (CDPD), Digital Advanced Mobile Phone System (D-AMPS), Frequency Division Multiple Access (FDMA), Global System for Mobile Communications (GSM), Mobitex, Personal Communications Services (PCS), RAM Mobile Data, ReFLEX, Short Message Service (SMS), or Time Division Multiple Access (TDMA). One skilled in the art will recognize that other wireless transmission protocols are possible. A person skilled in the art will also recognize that the wireless phone device 240 may perform other functions.

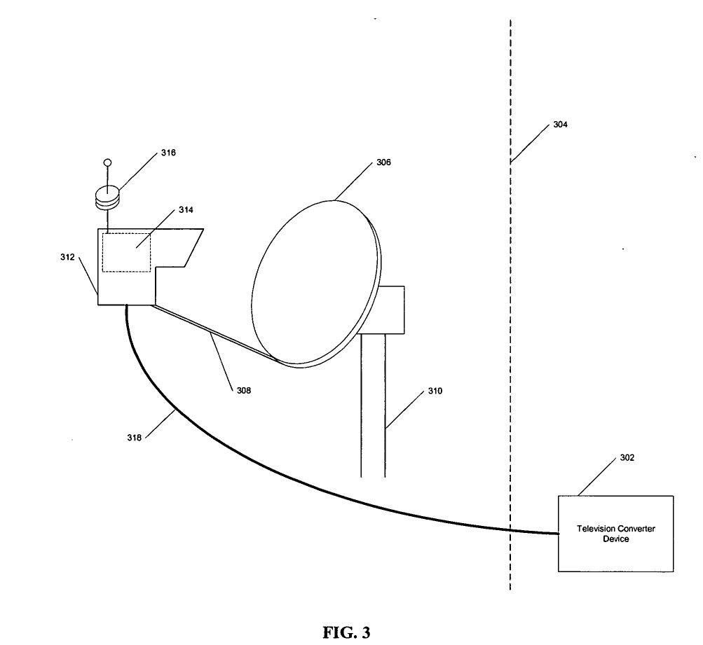

FIGS. 3-5 all relate to the physical mounting of the wireless phone device 314 and antenna 316. A typical satellite communications device 108 may include some or all of the components in FIGS. 3-5. These components may include a satellite dish 306 and a feedhorn 308 mounted on a mast 310. The mast 310 can be mounted to the structure of the subscriber's home or business (not shown). The feedhorn 308 holds the low-noise block filter (LNBF) 312. A cable 318 functions as the communications pathway between the LNBF 312 and the satellite set-top-box 302. In the embodiment, the satellite set-top-box 302 resides inside the subscriber's home or business while the other parts are outside the structure. This separation of the components is represented by the dotted line 304.

The wireless antenna 316 and wireless device 314 may be mounted or housed in several ways. One possibility is shown in FIG. 3. In this configuration, the wireless device 314 is housed at LNBF 312. The casing of the LNBF 312 protects both the electronics for the LNBF 312 and the wireless device 314. Some embodiments may have the wireless device 314 and the LNBF 312 as an integrated set of electronics, while other embodiments may separate the electronics. The wireless antenna 316 in this embodiment is mounted at LNBF 312. This configuration of the antenna 316 may require little additional cabling to connect the antenna to the satellite set-top-box. One skilled in the art will recognize that the antenna 316 may be mounted in other places, either on other components or somewhere else on the subscriber's structure. For example, the antenna 316 may be mounted within the structure housing the LNBF 312.

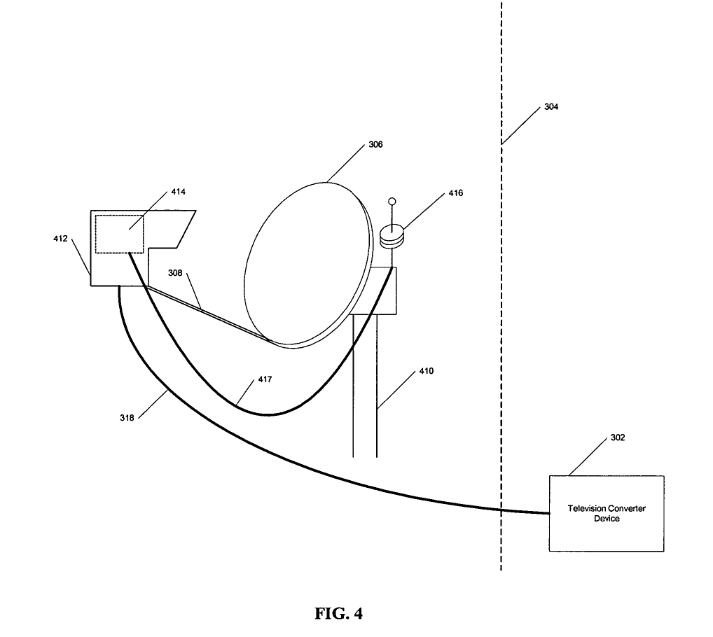

A second configuration is shown in FIG. 4. Here, the wireless device 414 is again housed at LNBF 412. However, the antenna 416 is now mounted at the mast 410 rather than the LNBF 412. This situation may allow the antenna 416 to obtain a better positioning for sending and receiving signals. A cable 417 may be used to send the wireless signals from the separated antenna 416 to the wireless device 414. One skilled in the art will recognize that cable 417 may be housed in or along mast 410.

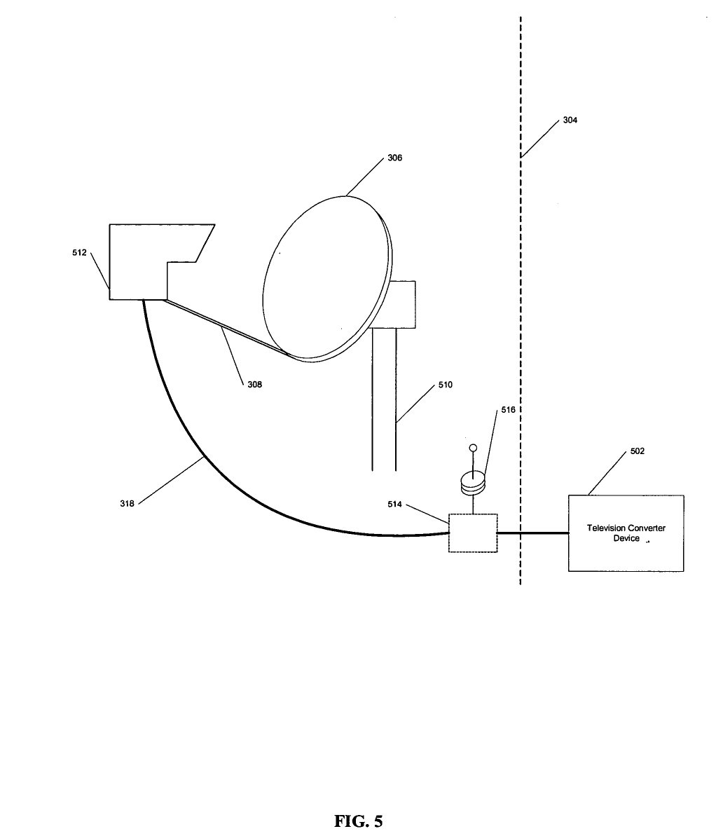

Another configuration is shown in FIG. 5. The wireless device 514 and the antenna 516 may be housed between the LNBF 512 and the satellite set-top-box 502. Since the system may be preexisting, it may not be possible to place the wireless device 514 in the housing with the LNBF 512. Thus, an external installation may be required. Using the existing cabling, the wireless device 514 may be placed in the circuit with the satellite set-top-box 502 and the LNBF 512. No further wiring may need to be installed. The wireless device 514 may then send wireless signals and relay any communications between the LNBF 512 and the satellite set-top-box 502. In another embodiment, this configuration may have a wireless antenna 516 located separate from the wireless device 514. One skilled in the art will recognize other techniques for mounting and installing the wireless device 514 and antenna 516.

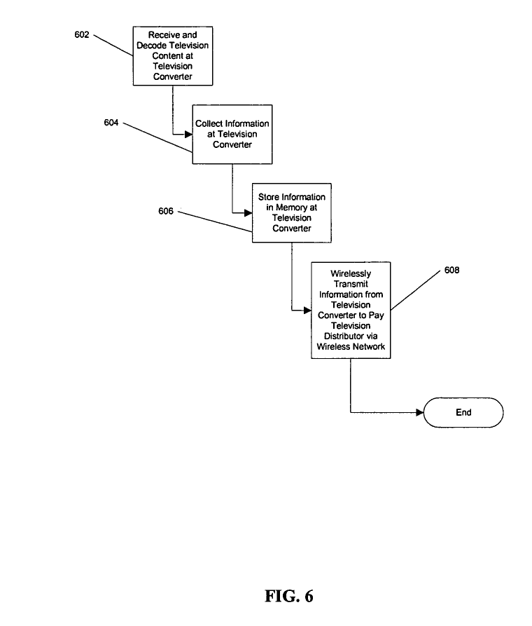

FIG. 6 shows one embodiment of a method for providing information from a television converter to a pay television distributor in accordance with the present invention. For example, a subscriber may send pay-per-view requests or other information to a pay television distributor. Pay television distributors, as discussed earlier, may include, but are not limited to, cable or satellite television distributors. In this embodiment, the television converter at a subscriber location receives and decodes 602 television content. Signal processing devices for receiving and decoding television content may include, but are not limited to, demodulators, decoders, demultiplexers, data packet selectors and conditional access processing. One skilled in the art will recognize that other devices, structures or techniques for receiving and decoding television content are possible. The television converter then collects 604 information to send to the pay television distributor. Information collected 604 at the television converter may include, but is not limited to, pay-per-view requests, account information or requests to change service. One skilled in the art will also recognize that information may contain non-television content, including, but not limited to, television converter usage data. Collected information 604 is stored 606 in memory at the television converter. One skilled in the art will recognize that memory may include, but is not limited to, RAM, ROM, magnetic, optical, removable or other storage devices. The collected information 604 is then wirelessly transmitted 608 from the television converter to a pay television distributor via one or more communications networks. One skilled in the art will recognize that many communications networks are possible, including, but not limited to, wireless phone networks, switched phone networks, cable networks, the Internet and proprietary data networks.

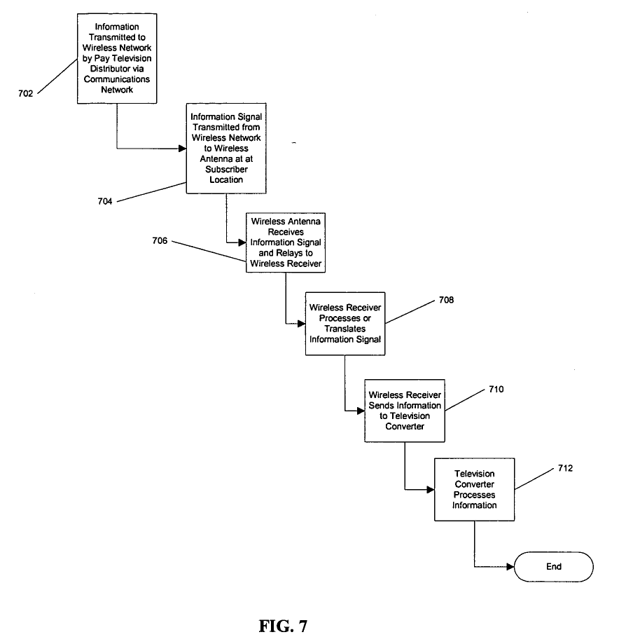

Some information may originate from the pay television distributor. In another embodiment, corresponding to FIG. 7, the television converter 100 may receive information sent to the subscriber by the pay television distributor. Information may include, but is not limited to, software updates, changes in service, account information, responses to pay-per-view requests or various other data. Pay television distributors may send information to one or more wireless phone numbers or known wireless devices. Information from pay television distributors is transmitted 702 through a communications network to a wireless network. The information transmitted to a wireless network 702 may then be transmitted 704 to the wireless antenna. One skilled in the art will recognize that the information transmitted from the pay television distributor to the subscriber may be encoded, converted, processed, transformed and translated by different communications and signaling protocols.

The wireless antenna receives and relays 706 the information to the wireless device. The information received and relayed 706 by the wireless antenna may be in the form of a signal that is analog, digital or some combination thereof. This information signal may be encoded and require processing by the wireless device prior to delivery to the television converter 100. The wireless device then processes or translates 708 the information signal using some wireless signal protocol. These wireless signal protocols may include, but are not limited to, 802.11, WiMAX, AMPS, ARDIS, CDMA, CDPD, D-AMPS, FDMA, GSM, Mobitex, PCS, RAM Mobile Data, ReFLEX, SMS, or TDMA. The wireless device may also translate the signal into DiSeqC or another similar protocol. The wireless device then sends 710 the information to the television converter 100. The television converter 100 can then process 712 the information. One skilled in the art will recognize that other structures or techniques for communicating with a wireless device are possible.

As is evident from the embodiments of FIGS. 6 and 7, a two-way communications pathway may be possible between the subscriber and pay television distributor. One skilled in the art will recognize that other structures or techniques for communicating with a distributor are possible.

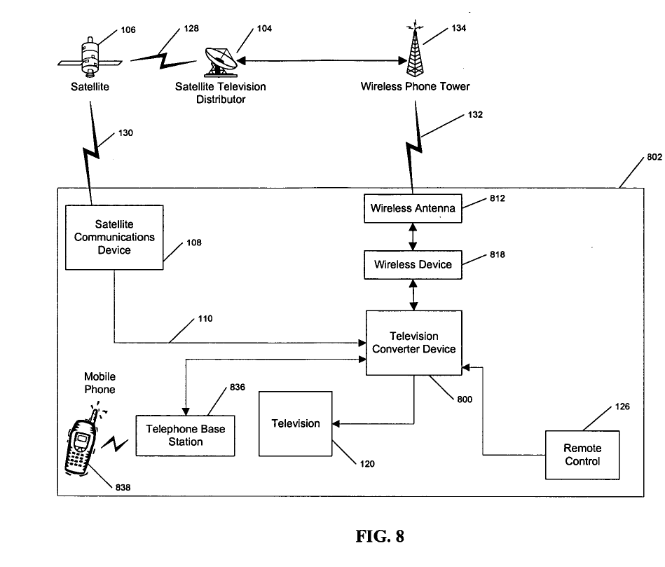

FIG. 8 shows another embodiment of a home entertainment system 802 with an attached telephone base station 836. The components and structures described in the embodiment described in FIG. 8 depart from the embodiment described in FIG. 1 only insofar as the addition of an attached telephone base station 836 and short-range mobile phone 838. A telephone base station 836 is attached to the satellite set-top-box 100, 800 to permit use of a home telephone system with the wireless device 818 and wireless antenna 812. In this embodiment, a short-range mobile phone 838 is wirelessly connected to the base station. In an alternative embodiment (not shown), a traditional corded telephone (not shown) and a phone line (not shown) may be used in place of or in combination with the short-range mobile phone 838 and telephone base station 836. The mobile phone 838 may be any type of cordless or portable phone transmitting on several frequencies such as 900 MHz or 2.4 GHz. One skilled in the art will recognize that other cordless phone transmission frequencies are possible. One skilled in the art will also recognize that other types of landline phones or customer premises equipment (CPE) may be used with the satellite set-top-box.

The mobile phone 838 can transmit the telephone signal to the base station 836. The base station 836 may act as a relay. After receiving the telephone signal, the base station 836 may send the signal to the satellite set-top-box 800. The base station 836 may communicate with the satellite set-top-box 800, for example, using an RJ-11 style telephone connection. The satellite set-top-box 800 may send the telephone signal to the wireless device 818 and wireless antennae 812 for transmission, for example, through the wireless network to the Public Switched Telephone Network (PSTN). Thus, the wireless device 818 may be used for data and voice transmissions. In another embodiment, the base station 836 may send the telephone signal directly to the wireless device 818. In this way, the satellite set-top-box 800 may be bypassed. One skilled in the art will recognize other methods for attaching the base station 836 or local telephone to the system.

We claim:

1. A method for providing information from a television converter to a pay television distributor comprising:
a. receiving and decoding television content at said television converter
b. collecting said information at said television converter;
c. storing said information in memory associated with said television converter; and,
d. transmitting said information wirelessly from a wireless transmitter associated with said television converter.

2. A method for providing information from a television converter to a pay television distributor according to claim 1 wherein said information relates to pay-per-view purchases obtained by a subscriber through said television converter.

3. A method for providing information from a television converter to a pay television distributor according to claim 1 wherein said wireless transmitter transmits to a receiver in a wireless phone network.

4. A method for providing information from a television converter to a pay television distributor according to claim 3 wherein said wireless phone network is a cellular phone network.

5. A method for providing information from a television converter to a pay television distributor according to claim 3 wherein the information is transmitted to said television distributor via said wireless phone network.

6. A method for providing information from a television converter to a pay television distributor according to claim 3 further comprising the steps of receiving telephone communications from a first telephone at said television converter and forwarding said telephone communications from said first telephone to a second telephone via said wireless phone network.

7. A method for providing information from a television converter to a pay televisions distributor according to claim 6 wherein said television converter receives telephone communications from said second telephone over said wireless phone network and forwards said telephone communications from said second telephone to said first telephone.

8. A method for providing information from a television converter to a pay television distributor according to claim 1 further comprising said television converter receiving non-television content information from said television distributor wirelessly.

9. A method for providing information from a television converter to a pay television distributor according to claim 8 wherein said non-television content information from said television distributor is received in a communication path which is distinct from the path which is used to receive television content by the television converter.

10. A subscriber television converter apparatus for receiving, decoding and displaying pay television content comprising:
a. a demodulator for demodulating said television content off of a carrier;
b. a decoder coupled to said demodulator for decoding said television content demodulated off of said carrier;
c. an encoder for encoding said television content for display on a television display device;
d. a conditional access module coupled to said television converter which allows access to television content which the subscriber is authorized to receive;
e. memory for storing information in said television converter;
f. a wireless transmitter coupled to said memory to transmit at least some of said stored information.

11. A subscriber television converter apparatus for receiving, decoding and displaying pay television content according to claim 10 wherein said wireless transmitter is adapted to transmit information to a wireless phone network.

12. A subscriber television converter apparatus for receiving, decoding and displaying pay television content according to claim 11 wherein said wireless transmitter is adapted to transmit information to a cellular phone network.

13. A subscriber television converter apparatus for receiving, decoding and displaying pay television content according to claim 11 further comprising a wireless receiver to receive information from said wireless phone network.

14. A subscriber television converter apparatus for receiving, decoding and displaying pay television content according to claim 13 further comprising an interface adapted to transmit information received from said wireless telephone network to a telephone coupled to said television converter and to receive information from said telephone and relay such information to said wireless telephone network.

15. A subscriber television converter apparatus for receiving, decoding and displaying pay television content according to claim 11 further comprising:
a. a satellite antenna for receiving said pay television content from a satellite transmission;
b. an antenna coupled to said wireless transmitter for transmitting said information to said wireless phone network.

16. A subscriber television converter apparatus for receiving, decoding and displaying pay television content according to claim 15 further wherein said antenna coupled to said wireless transmitter is mechanically coupled to said satellite antenna.

17. A subscriber television converter apparatus for receiving, decoding and displaying pay television content according to claim 16 further comprising a low noise block down converter mechanically coupled to said satellite antenna wherein said antenna coupled to said wireless transmitter is housed at said low noise block down converter.

18. A subscriber television converter apparatus for receiving, decoding and displaying pay television content according to claim 17 wherein the low noise block down converter and the antenna coupled to said wireless transmitter are housed within a single housing.
